(19) United States
(12) Patent Application Publication
(10) Pub. No.: US 2011/0026033 A1
(43) Pub. Date: Feb. 3, 2011

(54) Optical Inspection Using Spatial Light Modulation

(75) Inventors: James D. Trolinger, Costa Mesa, CA (US); Amit K. Lal, Ladera Ranch, CA (US); Joshua Jo, La Habra, CA (US); Stephen Kupiec, Irvine, CA (US)

Correspondence Address: HAYNES AND BOONE, LLP;IP Section, 2323 Victory Avenue, Suite 700, Dallas, TX, 75219, US

(73) Assignee: METROALASER, INC., Irvine, CA (US)

(21) Appl. No.: 12/644,009

(22) Filed: Dec. 21, 2009

Related U.S. Application Data
(63) Continuation of application No. 61/139,438, filed on Dec. 19, 2008.

(51) Int. Cl. G01B 9/02

(52) U.S. Cl. 356/450

(57) ABSTRACT

A Hartmann inspection system is provided that includes, comprising: a laser source; and a spatial light modulator (SLM) configured to form at least one aperture to form an object beam for inspecting an object, wherein the SLM is further configured to modulate the aperture with a diffraction grating.

### RELATED APPLICATION

This application claims the benefit of U.S. Provisional Application No. 61/139,438, filed Dec. 19, 2008.

### STATEMENT REGARDING FEDERALLY SPONSORED RESEARCH OR DEVELOPMENT

The invention was made under a contract with agencies of the United States Government. The name of the agencies and the Government contract numbers are: MD03 (U.S. Army & Missile Defense Command)—Contract No.: W9113M-09-C-0006; N003 (NASA Goddard Space Flight Center)—Contract No.: NNX08CA25C; and NP05 (U.S. Navy/NAVAIR)—Contract No.: N68936-07-C-0045.

### TECHNICAL FIELD

The present invention relates generally to optical inspection to determine surface dimensions of an object, and more particularly, to the determination of such dimensions using spatial light modulation for both a Hartmann inspection and an interferometric inspection.

### BACKGROUND

It is often the case that the optical properties of an object must be characterized with a high degree of precision. For example, a heat-seeking missile will track heat-emitting targets through a nose cone. The optical properties of the nose cone will depend upon how perfectly the nose cone approximates the desired shape such as an ogive. To guarantee that a nose cone will provide the desired optical properties, a manufacturer will measure the optical properties of the nose cone to very fine tolerances. Similarly, satellite-based telescopes will have optical components such as a mandrel that have finely-controlled surfaces whose optical properties must be known with high precision. To meet the industrial demands for such precise optical characterizations, various applications such as Shack-Hartmann sensing have been developed.

In Shack-Hartmann sensing, the object being characterized is illuminated with spatially-distributed pencil beams of light. The wavefront from an optical source is divided into the pencil beams using a micro-lens array. Depending upon the testing configuration, the Hartmann beams from the micro-lens array will either transmit through or be reflected by the sensed object. The resulting transmission or reflection of the Hartmann beams is determined by analyzing their intersection locations with regard to an imaging sensor such as a charge coupled device (CCD) sensor. These object beam intersections are then compared to a reference set of intersections. For a reflective test, these reference set of intersections are produced by replacing by a flat mirror. In a transmissive test, the object is simply removed and the micro-lens array directly illuminates the sensor to produce the reference intersections. One can predict the direction the Hartmann beams will propagate into after interaction with an idealized version of the sensed object. In this fashion, a deviation from the idealized or desired optical behavior for the sensed object may be characterized using Shack-Hartmann inspection.

But conventional Shack-Hartmann inspection suffers from a number of limitations. For example, sensitivity requires a longer focal length from the microlens array but Hartmann sensing at such longer focal lengths suffers from ambiguity. In other words, Shack-Hartmann sensing requires a knowledge of which lens in the micro-lens array produced which point of interception on the sensor. As the focal length is increased, the possibility that one beam interception point overlaps with another is increased. Another issue for Shack-Hartmann inspection is that any aberration in the wavefront received by the sensor introduces a corresponding aberration in the focused spots at the sensor, which makes finding the centroid of the aberrated focused spot difficult In addition, the spatial resolution for Shack-Hartmann sensing is limited to the lens diameter for the micro-lens array. Accordingly, there is a need in the art for improved Hartmann inspection systems that address these limitations.

As compared to Shack-Hartmann inspection, a finer resolution of optical properties can generally be obtained through interferometric inspection. However, interferometric inspection is typically limited to the inspection of objects having relatively smooth surfaces whereas Shack-Hartmann techniques can accommodate rougher surfaces. An issue for interferometric inspection is the number of interference fringes that result in the interferogram. For example, a conventional charge-coupled device (CCD) sensor can effectively accommodate around 50 or perhaps even as many as 100 interference fringes in the resulting interferogram it senses. The number of interference fringes that result from the object beam width will depend upon the optical properties in resulting illuminated portion of the object being sensed. Relatively-highly-curved surface geometries such as an ogive will thus require more time for interferometric inspection. Thus, there is a need in the art for improved interferometric inspection techniques that can accommodate the inspection of relatively curved surfaces in a more efficient fashion.

### SUMMARY

In accordance with one embodiment of the present invention, a Hartmann inspection system is provided that includes, comprising: a laser source; and a spatial light modulator (SLM) configured to form at least one aperture to form an object beam for inspecting an object, wherein the SLM is further configured to modulate the aperture with a diffraction grating.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is a diagram of a reflective hybrid optical inspection system.

FIG. 2 is a diagram of a transmissive hybrid optical inspection system.

FIG. 3 illustrates a perspective view of the system of FIG. 2.

FIG. 4 illustrates a sample grating for the SLM microdisplay of FIGS. 1 and 2 during a Hartmann inspection.

FIG. 5 illustrates the SLM microdisplay of FIG. 5 screened to produce a single Hartmann beam.

FIG. 6 illustrates the scanning of the single aperture of FIG. 5 across the SLM microdisplay.

FIG. 7a shows an ogive portion illuminated by the system of FIG. 2.

FIG. 7b shows a resulting interferogram without any wavefront pre-conditioning by the SLM.

FIG. 7c shows a resulting interferogram after wavefront pre-conditioning by the SLM.

Embodiments of the present invention and their advantages are best understood by referring to the detailed description that follows. It should be appreciated that like reference numerals are used to identify like elements illustrated in one or more of the figures.

### DETAILED DESCRIPTION

A hybrid Hartmann and interferometric inspection system is provided that uses a holographic spatial light modulator (SLM). As known in the art, an SLM has a certain microdisplay size corresponding to an array of pixels within the display that can modulate the phase and amplitude (and possibly polarization) of the light processed by each pixel. In a Hartmann mode of operation, the SLM microdisplay is used to adaptively form at least one aperture such that a resulting Hartmann beam may be scanned across the object as desired. The number of possible scan locations is limited only by the pixel resolution within the SLM. In this fashion, a user may have nearly unlimited spatial resolution at relatively arbitrary levels of sensitivity yet not suffer from the ambiguity of prior art Hartmann techniques. Moreover, the wavefront across the aperture may be modulated as desired such that the focal length can be increased or decreased as necessary, speckle effects are eliminated or reduced, and aberrations in the object beam addressed.

In the interferometric mode, the SLM preconditions the wavefront for the object beam to reduce the resulting number of interference fringes within the interferogram. In other words, the preconditioning acts as a virtual reference object such that the interferogram is merely measuring the difference (with respect to the reference beam) between the virtual reference object introduced by the SLM wavefront preconditioning and the actual object being characterized. It will be appreciated that an SLM may be exploited in a dedicated as compared to a hybrid system. In other words, although the following discussion will be dedicated to a hybrid inspection system, that hybrid system is readily modified to be dedicated to a Hartmann-only or an interferometric-only inspection system. As known in the art, to characterize the optical properties for the object portion tested by an interferogram requires multiple phases with regard to the object beam and the reference beam. In other words, a conventional interferometric analysis would require four different interferograms with the object beams at 0 degrees, 90 degrees, 180 degrees, and 270 degrees (or some other suitable set of phases) with respect to each other. To simplify such a cumbersome interferometric analysis, the present assignee has developed a sensor that includes a pixelated phase mask such that all four interferograms can be completed simultaneously. An example of such a pixelated phase mask is disclosed in U.S. Pat. No. 6,304,330, the contents of which are incorporated by reference. Thus, the following discussion will assume without loss of generality that the hybrid system sensor incorporates such a pixelated phase mask. However, it will be appreciated that a hybrid system may be constructed using conventional sensors that do not incorporate a pixelated phase mask.

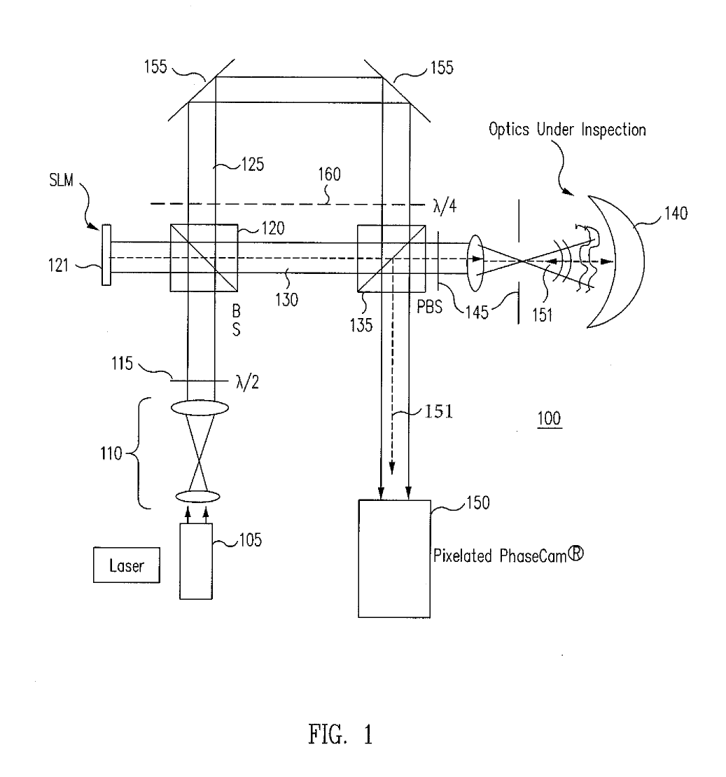

Turning now to the drawings, a hybrid inspection system 100 is illustrated in FIG. 1. A laser 105 or other suitable coherent source provides a light beam that is suitably spread and collimated using lenses 110 and processed by a one-half waveplate 115 before being received by a beam splitter 120. Splitter 120 splits the received beam into an object or test beam that is then modulated by a spatial light modulator (SLM) 121 whereas a remaining split beam propagates through splitter 120 as a reference beam 125. A resulting modulated object beam 130 from SLM 121 passes through splitter 120 to a polarization beam splitter (PBS) 135. One-half waveplate 115 has introduced the appropriate polarization (for example, vertical or horizontal) such that PBS 130 passes through the modulated beam 130 towards an object 140 being characterized by hybrid system 100. A one-quarter waveplate 145 rotates the polarization such that a resulting reflected beam from object 140 does not pass through PBS 145 but is instead reflected towards a sensor 150 as a test beam 151. In an interferometric mode, sensor 150 will also receive reference beam 125 as reflected by mirrors 155. However, since there is no need for a reference beam in a Hartmann mode of operation, mirrors 155 may be blocked from reflecting reference beam 125 through imposition of an opaque screen (or screens) 160.

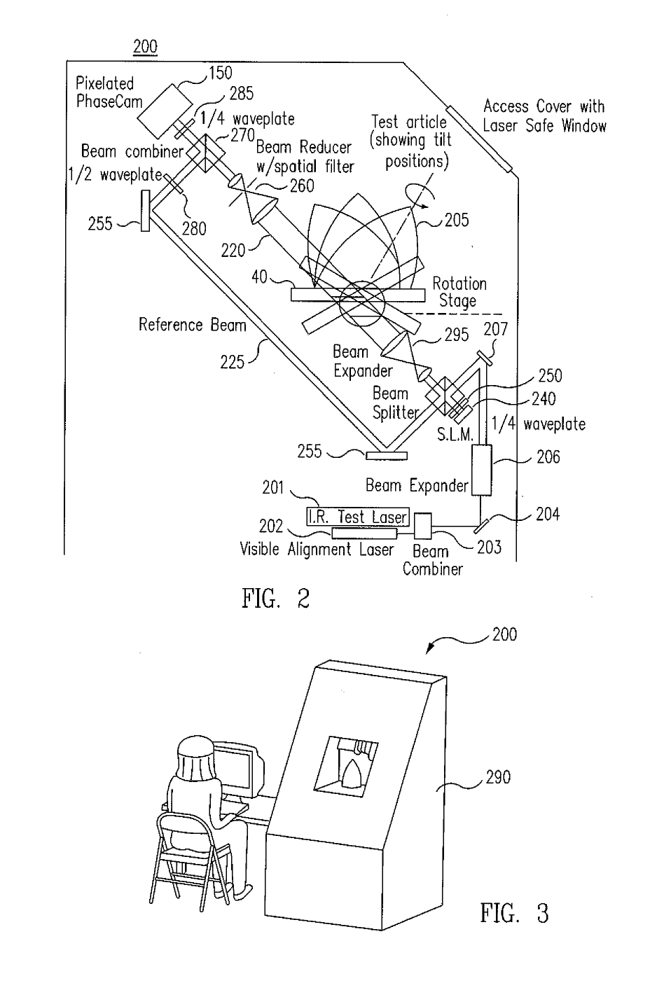

System 100 may be operated first in a Hartmann mode to approximate the optical properties of object 140. As illustrated in FIG. 1, system 100 acts in a reflective mode in that object 140 is illuminated and a resulting reflected test beam 151 processed by sensor 150 as the object/test beam. However, system 100 is readily modified into a transmissive mode of operation as discussed further with regard to FIG. 2 where a test beam resulting from the object being characterized is not reflected but instead transmits through object 140. Regardless of whether a reflective or transmissive mode is implemented, the resulting hybrid system will measure what conventional Hartmann or interferometric systems are known to measure—an interferometric system characterizes the optical path length difference between the reference beam and the test beam whereas a Hartmann system characterizes an optical gradient across the test beam wavefront. In a reflective mode, the hybrid system will thus be indirectly characterizing the surface shape for the object in that it is the surface that is performing the reflection. In a transmissive mode, the hybrid system will thus be characterizing the optical properties of the object with regard to a specific orientation and illumination as will be explained further herein.

A transmissive hybrid system 200 is shown in FIG. 2. In system 200, an object being characterized is an ogive nose cone 205. Ogive 205 is placed on a tilting rotation stage 210. The tilt of stage 210 determines what part of ogive 205 is being characterized with respect to an object or test beam 220 that enters through the ogive base and exits through a corresponding portion of an outer surface for ogive 205. By then rotating stage 210 at a given tilt, the 360 degrees of optical behavior at that tilt for ogive 205 are characterized. In this fashion, the entire optical behavior of ogive 205 can be characterized with respect to transmission of light between the outer ogive surface and the ogive base. An laser source such as an IR laser source 201 and a visible alignment laser (for testing initial configuration) 202 are combined through a beam combiner 203 to drive a mirror 204 and a beam expander 206 accordingly. Upon reflection from a mirror 207, an incident beam gets split by a PBS 215 into a reference beam 225 and a test or object beam 220. Object beam 220 is first reflected back towards an SLM 240 so that it can be modulated as desired before it passes through SLM a second time and is expanded by a beam expander 245. A quarter waveplate 250 changes the polarization of object beam 220 so that object beam 220 does not contribute to reference beam 225. After passing through the desired portion of cone 205 as determined by the tilt and rotation of stage 210, object beam 220 is received by a beam reducer 260 that may include a spatial filter to reduce optical noise. The resulting reduced object beam from reducer 260 passes through a beam combiner 270 towards a sensor 150. Reference beam 225 is also received by beam combiner 270 after appropriate reflection by mirrors 255 so that reference beam 225 may also be received by sensor 150. A one-half waveplate 280 and a quarter waveplate 258 adjusts the polarization of reference beam 225 for optimal reception by sensor 150. Quarter waveplate 285 also adjusts the polarization of object beam 220 in this fashion.

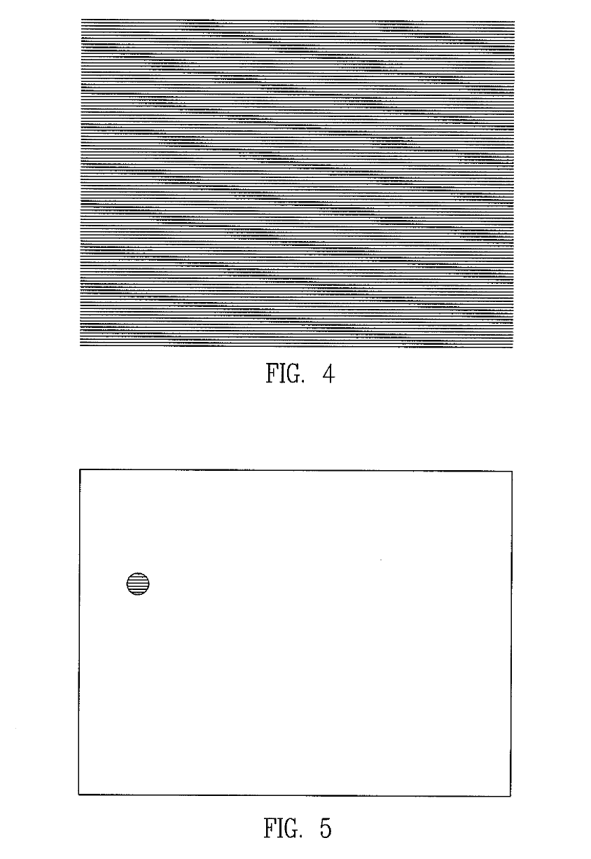

A housing 290 covers system 220 to protect an operator from stray laser reflections. Housing 290 includes a laser-safe inspection window 295 to allow the operator to verify operation of system 200. A perspective view of the housing 290 and system 200 in operation is shown in FIG. 3. A user interfaces with a computer system to monitor operation of system 200. A software program running on the computer system controls the operation of the rotation stage 210 and SLM 240 to effect the desired mode of operation. For example, in a Hartmann mode of operation, the software may command SLM 240 to generate a “blazed” grating pattern as seen in FIG. 4. This grating pattern is quite arbitrary in that one merely needs the presence of some grating pattern so that it can be adjusted as discussed further herein to reduce laser speckle. Given this grating, the SLM's microdisplay is windowed as shown in FIG. 5 to form a resulting Hartman beam used to interrogate ogive 240. Although just one aperture or window is formed by the SLM microdisplay in FIG. 5, it will be appreciated that multiple Hartmann beams may be transmitted simultaneously. Transmission of just one Hartmann beam, however, allows system 200 to have zero ambiguity about the identity of the resulting focused illumination spot on sensor 150. Conversely, by increasing the number of Hartmann beams that are simultaneously transmitted by SLM 240, system 200 will complete a Hartmann inspection more quickly. Thus, the number of beams transmitted by an SLM in a hybrid system as disclosed herein will depend upon a tradeoff between sensitivity and test completion time. The following discussion will assume without loss of generality that just one Hartmann beam is transmitted to form the test or object beam.

To reduce speckle at the sensor 150, the mask pattern shown in FIG. 5 may be repeated but with the grating pattern shifted by a factor of π/4. This results in a “piston term” on the wavefront for the test beam in that the intensity is not affected but the phase across the wavefront is shifted by the piston term. This phase shift affects the distribution of speckle accordingly. By performing eight successive measurement cycles where each cycle includes a gradient shift by π/4 relative to the preceding cycle and then averaging the resulting measurements, system 200 greatly reduces the result of speckle since the individual speckles in each measurement will be averaged out.

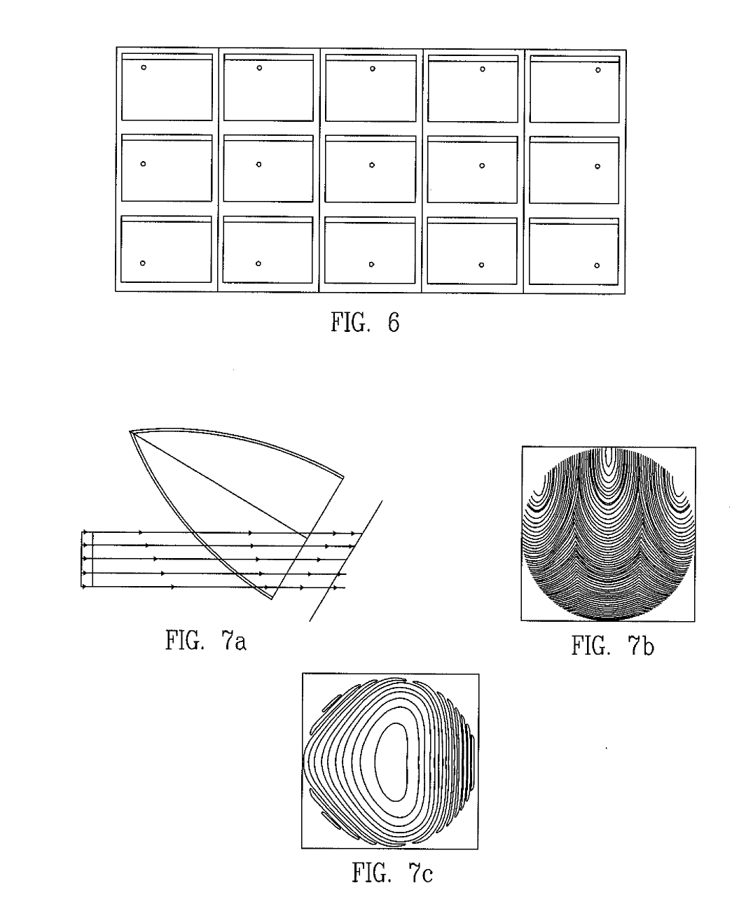

Notice the advantages of such a Hartmann inspection—as seen in FIG. 2, system 200 can illuminate a certain portion of object 205 at any given tilt and rotation of stage 210. For example, in one embodiment, the Hartmann-testable portion of object 205 with respect to the SLM microdisplay is around two-square inches in cross-section. By varying the aperture location formed by the SLM microdisplay, this illuminated portion may be scanned with an appropriate number of Hartmann beams. For example, as seen in FIG. 6, the SLM may be software-commanded to scan across the available SLM display surface in fifteen different locations. Such scanning would thus produce fifteen different resulting Hartmann beams that would sample the Hartmann-testable portion for this tilt and rotation of stage 210 of object 205 as respective test beams 220. The number of Hartmann beams necessary to characterize the Hartmann-testable portion at any given tilt and rotation will depend upon the characteristics of the object being tested and the desired spatial resolution and sensitivity.

During a Hartman inspection, the reference beam is blocked off as discussed with regard to FIG. 1. Thus, sensor 150 is used merely as an imaging device during a Hartmann inspection. As compared to prior art Hartmann approaches, systems 100 and 200 allow a user to measure with little or no aberration since any aberration in the focused spots on the sensor may be accounted for with the appropriate grating modulation introduced by the SLM. Moreover, since the SLM forms its apertures in a dynamic fashion, the resulting Hartmann beams may be scanned over the test object at any desired location and at any desired focal length. By selecting the apertures in this dynamic fashion (depending upon the vagaries of whatever object is being characterized), the SLM can avoid situations where certain aperture selections result in overlapping spots at the sensor. The number of Hartmann beams is only limited by the pixel size in the SLM microdisplay such that there is virtually no spatial resolution limit with regard to the scanned objects. In this fashion, all three issues discussed previously with regard to prior art Hartmann approaches are addressed.

Although Hartmann sensing as just described could be used to characterize an object to a desired resolution and sensitivity, the measurements take some time as the various aperture locations shown in FIG. 6 are generally taken sequentially to avoid any ambiguity in the resulting focused spot identity at the sensor. Thus, a Hartmann scan can be performed at an approximate spatial resolution to determine a rough optical gradient for Hartman-testable portion. A software program may then be employed to determine the resulting wavefront that would have produced such an optical gradient. This knowledge of the approximate wavefront corresponding to the Hartmann-testable portion may then be exploited in an interferometric mode as follows.

As discussed previously, the Hartmann testing occurs with respect to a possible testable portion at any given tilt and rotation of the object being tested. In other words, if the SLM microdisplay were not windowed in any fashion as discussed with regard to FIGS. 5 and 6, a circular beam having some diameter will illuminate the object. For example, in one embodiment such a object beam 220 (FIG. 2) or 130 (FIG. 1) may be 2 inches across in diameter. Given a relatively curved object such as ogive 205 of FIG. 2, the resulting number of diffraction fringes in the interferogram will be relatively large. For example, the intersection of such a 2″ beam near the base of an ogive is shown in FIG. 11a. FIG. 11b illustrates the resulting interferogram if the SLM introduces no pre-conditioning: in other words if the object beam is a plane wave. As can be seen from FIG. 11b, there are too many interference fringes (approximately 200) to characterize the optical properties for this ogive portion. However, if a Hartmann sensing of this portion is performed as discussed previously, the waveform in the object beam after passing through this ogive portion can be approximated. Since the SLM discussed with regard to FIGS. 1 and 2 is modulating the object beam, the inverse of this wavefront can be modulated onto the object beam by the SLM. In essence, the SLM is subtracting the 200 interference fringes that would result in the interferogram without this pre-conditioning. Alternatively, the SLM may be located in the reference beam path. In such embodiments, the SLM would pre-condition the reference beam to match the expected wavefront for the object beam as opposed to introducing the inverse of such a waveform. Regardless of whether the SLM is located within the reference or object beam path, the resulting interferogram has far fewer interference fringes as seen in FIG. 7c. In this fashion, the interferogram can characterize the portion shown in FIG. 7a in just one measurement whereas a prior art approach would require much narrower beams and thus more interferograms and time to characterize this portion.

Although the preceding discussion is directed to hybrid systems that can practice both Hartmann and interferometric inspections, it will be appreciated that the disclosed systems are readily modified to be dedicated to purely Hartmann or interferometric inspection techniques. Thus, the embodiments described above illustrate but do not limit the invention. It should also be understood that numerous modifications and variations are possible in accordance with the principles of the present invention. Accordingly, the scope of the invention is defined only by the following claims.

1. An inspection system, comprising:
a laser source; and
a spatial light modulator configured to form at least one aperture to form an object beam for inspecting an object, wherein the spatial light modulator is further configured to modulate the aperture with a diffraction grating.

2. The inspection system as recited in claim 1, wherein the aperture(s) are configured to facilitate the performance of a Hartmann inspection.

3. The inspection system as recited in claim 1, wherein the interference grating is configured to facilitate the performance of an interferometric inspection.

4. The inspection system as recited in claim 1, wherein the spatial light modulator is configured to form a plurality of apertures.

5. The inspection system as recited in claim 1, wherein the spatial light modulator is configure to farm a plurality of apertures so as to form a plurality of object beams.

6. The inspection system as recited in claim 1, wherein the spatial light modulator is further configured to scan the object beam across the object being inspected.

7. The inspection system as recited in claim 1, wherein the spatial light modulator is further configured to modulate the aperture so as to do at least one of: changing a focal length of the object beam, mitigating speckle of the object beam, and mitigating an aberration of the object beam.

8. The inspection system as recited in claim 1, wherein the spatial light modulator is further configured to precondition a wavefront of the object beam so as to reduce the number of interference fringes within an interferogram.

9. The inspection system as recited in claim 1, further comprising a sensor for sensing laser light from an object being tested, the sensor including a pixilated phase mask.

10. The inspection system as recited in claim 1, further comprising a pixilated phase mask configured to facilitate the making of four interferograms simultaneously.

11. A method for performing inspections, the method comprising:
providing laser light;
forming at least one aperture with a spatial light modulator to define an object beam from the laser light; and
modulating the aperture with a diffraction grating.

12. The method as recited in claim 11, wherein forming at least one aperture is performed to facilitate a Hartmann inspection.

13. The method as recited in claim 11, wherein modulating the aperture is performed to facilitate an interferometric inspection.

14. The method as recited in claim 11, wherein forming at least one aperture is performed to facilitate a Hartmann inspection having comparatively less resolution and modulating the aperture is performed to facilitate an interferometric inspection having comparatively more resolution.

15. The method as recited in claim 11, wherein fanning at least one aperture is performed to facilitate a Hartmann inspection and the Hartmann inspection facilitates enhanced performance of an interferometric inspection.

16. The method as recited in claim 11, wherein forming at least one aperture comprises forming a plurality of apertures.

17. The method as recited in claim 11, further comprising scanning the object beam across an object being inspected.

18. The method as recited in claim 11, further comprising scanning the object beam across an object being inspected via the spatial light modulator.

19. The method as recited in claim 11, wherein modulating the aperture with a diffraction grating comprises modulating the aperture so as to do at least one of: change a focal length of the object beam, mitigate speckle of the object beam, and mitigating an aberration of the object beam.

20. The method as recited in claim 11, further comprising using the spatial light modulator during an interferometric inspection to precondition a wavefront of the object beam so as to reduce the number of interference fringes within a interferogram.

21. The method as recited in claim 11, further comprising using the spatial light modulator during an interferometric inspection to precondition a wavefront of the reference beam so as to reduce the number of interference fringes within a interferogram.
